(19) United States
(12) Patent Application Publication
(10) Pub. No.: US 2007/0139872 A1
(43) Pub. Date: Jun. 21, 2007

(54) Display device assembly

(76) Inventors: Youn Bum Lee, Ulsan-si (KR); Nam Cheol Hyeong, Ulsan-si (KR)

Correspondence Address: LEE & MORSE, P.C., 3141 FAIRVIEW PARK DRIVE, SUITE 500, FALLS CHURCH, VA, 22042, US

(21) Appl. No.: 11/606,884

(22) Filed: Dec. 1, 2006

(30) Foreign Application Priority Data
Dec. 2, 2005 (KR) 2005-117179

(51) Int. Cl. G06F 1/16

(52) U.S. Cl. 361/681; 349/58

(57) ABSTRACT

A display device may include a liquid crystal display panel, a back light assembly including a light source for supplying light to the liquid crystal display panel, a light guiding member included in the back light assembly to supply light from the light source to the liquid crystal display panel, a frame for accommodating the liquid crystal panel, the light source, and the light guiding member, a first protrusion formed on each of a first side and a second side of the light guiding member, the first protrusions extending from a lower or upper portion of the first and second sides, and at least one second protrusion formed at least on a third side of the light guiding member, the second protrusion extending from a lower or upper portion of the third side, wherein the at least one second protrusion is shorter than at least one of the first protrusions.

### BACKGROUND OF THE INVENTION

1. Field of the Invention

The present invention relates to assembly structures for electronic display devices. More particularly, the present invention relates to an assembly structure of a light guiding member and a support member for a display device.

2. Discussion of the Related Art

Various types of flat panel displays (FPDs), e.g., liquid crystal displays (LCDs), field emission displays (FEDs), plasma display panels (PDPs), and light emitting displays (LEDs), are being developed. Flat panel displays are replacing conventional cathode ray tubes (CRTs) because flat panel displays may be manufactured to be smaller, thinner and lighter than CRTs, even while having the same-size or a larger/wider-size viewing screen.

For example, LCDs may be smaller, lighter and less power consuming, thereby overcoming disadvantages of conventional CRTs. Thus, LCDs are substituting CRTs. LCDs may be manufactured in a wide range of sizes and may be employed with electronic devices of various sizes, e.g., large-sized monitors and TVs, small portable electronic devices such as mobile telephones and personal digital assistants.

Simpler and less costly assembly methods and elements are desired in order to help reduce fabrication time and cost of display devices.

### SUMMARY OF THE INVENTION

The present invention is therefore directed to structures for support members and light guiding members, which substantially overcome one or more of the problems due to the limitations and disadvantages of the related art.

It is therefore a feature of an embodiment of the invention to provide structures for support members and light guiding members that employ a fewer number of protrusions and/or receiving portions on sides thereof such that an assembly of the protrusions with the respective receiving portions may be simplified.

It is therefore a separate feature of an embodiment of the invention to provide structures for support members and light guiding members for reducing a time and cost of assembly of a light guiding member with a support member.

At least one of the above and other features and advantages of the present invention may be realized by providing a display device including a liquid crystal display panel, a back light assembly including a light source for supplying light to the liquid crystal display panel, a light guiding member included in the back light assembly to supply light from the light source to the liquid crystal display panel, a frame for accommodating the liquid crystal panel, the light source, and the light guiding member, a first protrusion formed on each of a first side and a second side of the light guiding member, the first protrusions extending from a lower or upper portion of the first and second sides, and at least one second protrusion formed at least on a third side of the light guiding member, the second protrusion extending from a lower or upper portion of the third side, wherein the at least one second protrusions is shorter than at least one of the first protrusions.

The first side and the second side of the light guiding member may be opposed to each other. The light guiding member may include a fourth side where the light source may be arranged, and the third side of the light guiding member opposes the fourth side of the light guiding member. A thickness of the first protrusions may range from about 0.4 times to about 0.6 times a thickness of the light guiding member. A thickness of the second protrusions may range from about 0.4 times to about 0.6 times a thickness of the light guiding member. A thickness of the first protrusions may ranges from about 0.4 times to about 0.6 times the thickness of the light guiding member.

The frame may include first receiving portions for receiving the first protrusions and at least one second receiving portion for receiving the at least one second protrusion, the first and second receiving portions being formed in lower or upper portions of internal sides of the frame, wherein when the first protrusions and the at least one second protrusion are formed on the lower portions of the first, second and third sides of the light guiding member, respectively, the first and second receiving portions may be formed on the lower portions of the internal sides of the frame, and when the first protrusions and the at least one second protrusion are formed on the upper portions of the first, second and third sides of the light guiding member, respectively, the first and second receiving portions may be formed on the upper portions of the internal sides of the frame.

At least one of the first receiving portions may be formed on each of first and second sides of the frame, the first and second sides of the frame opposing each other and correspond to the first and second sides of the light guiding member when the light guiding member and the frame are in an assembled state. At least one second receiving portion may be formed on the third side of the frame that opposes a fourth side of the frame where the light source may be arranged.

The first receiving portions may extend further than the at least one second receiving portion. The first protrusions may extend substantially along an entire distance of the respective one of the first and second sides of the light guiding member. The display device may include a reflecting member arranged below the light guiding member.

At least one of the above and other features and advantages of the present invention may be separately realized by providing a light guiding member employable in a display device, the light guiding member including an upper surface and a lower surface that overlaps with the upper surface, first, second and third side surfaces, a first protrusion extending from a lower portion or upper portion of each of the first side surface and the second side surface of the light guiding member, at least one second protrusion extending from a lower portion or upper portion of the third side surface of the light guiding member, wherein the at least one second protrusion extends along the third side surface a shorter distance than at least one of the first protrusions extends along the respective one of the first and second side surfaces.

A thickness of the first protrusions may range from about 0.4 times to about 0.6 times a thickness of the light guiding member. A thickness of the second protrusions may range from about 0.4 times to about 0.6 times a thickness of the light guiding member. The first protrusions may extend along substantially an entire length of the respective first and second side surfaces.

An upper portion of each of the first, second and third side surfaces may be free of protrusions. A fourth side surface of the light guiding member that opposes the third side surface of the light guiding member may be free of protrusions.

At least one of the above and other features and advantages of the present invention may be realized by separately providing a frame structure connectable to a light guiding member of a display device, the frame structure including first, second and third inner side surfaces, a first receiving portion on a lower or lower portion of each of the first and second inner side surfaces of the frame, at least one second receiving portion on a lower or upper portion of the third inner side surface of the frame, wherein the first receiving portions have a length along the respective first and second side surfaces of the frame that may be longer than a length of the at least one second receiving portion that extends along the third side surface of the frame. The first inner side surface and the second inner side surface of the frame may be opposed to each other.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates an exploded, perspective view of an exemplary portable display device employing one or more aspects of the invention;

FIGS. 2A and 2B illustrate front and rear perspective views, respectively, of an exemplary light guiding member according to one or more aspects of the invention;

FIGS. 3A and 3B illustrate front and rear perspective views, respectively, of an exemplary embodiment of a frame according to one or more aspects of the invention;

FIGS. 4A and 4B illustrate front and rear perspective views, respectively, of the exemplary frame and the exemplary light guiding member illustrated in FIGS. 2A to 3B in an assembled state; and

FIG. 5 illustrates a sectional view of the light guiding member and the frame illustrated in FIG. 1, taken along the line A-A′ of FIG. 4A.

### DETAILED DESCRIPTION OF THE INVENTION

Korean Patent Application No. 2005-117179, filed on Dec. 2, 2005, in the Korean Intellectual Property Office, and entitled: “Portable Display Device,” is incorporated by reference herein in its entirety.

The present invention will now be described more fully hereinafter with reference to the accompanying drawings, in which exemplary embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the figures, the dimensions of elements and regions are exaggerated for clarity of illustration. It will also be understood that when an element is referred to as being “on” another element, it can be directly on the other element, or intervening elements may also be present. Further, it will be understood that when an element is referred to as being “under” another element, it can be directly under, and one or more intervening elements may also be present. In addition, it will also be understood that when an element is referred to as being “between” two elements, it can be the only layer between the two elements, or one or more intervening elements may also be present. Like reference numerals refer to like elements throughout.

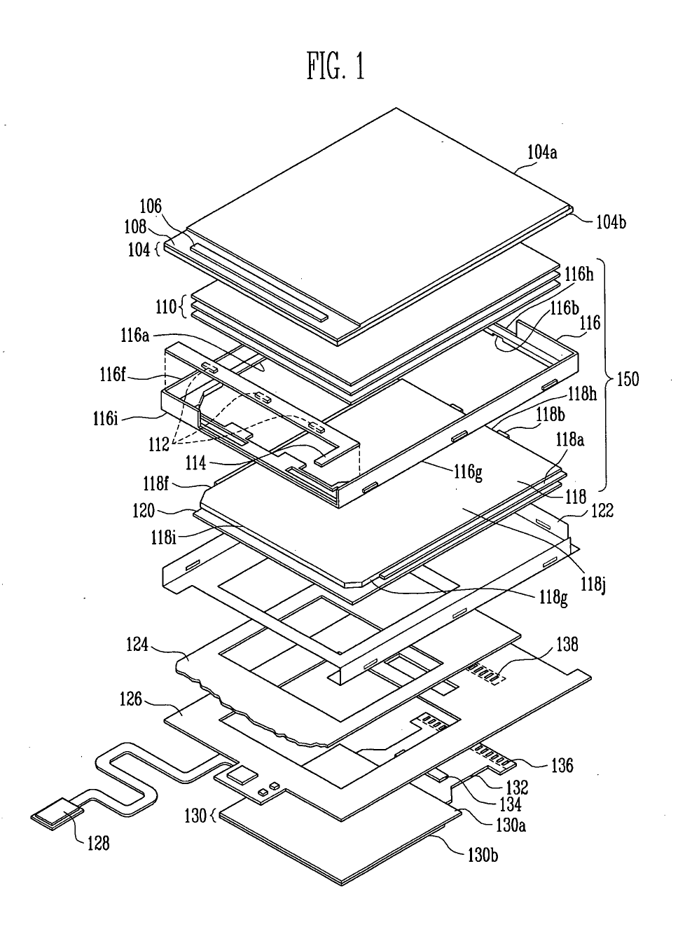

Hereinafter, exemplary embodiments of aspects of the present invention will be described with reference to FIGS. 1 to 5.

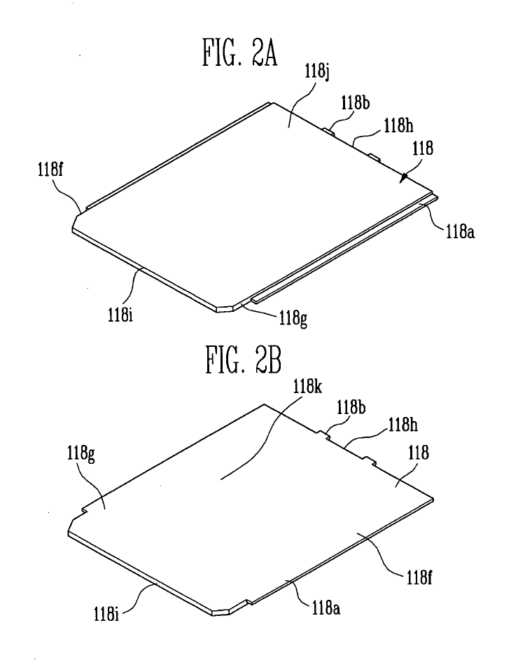

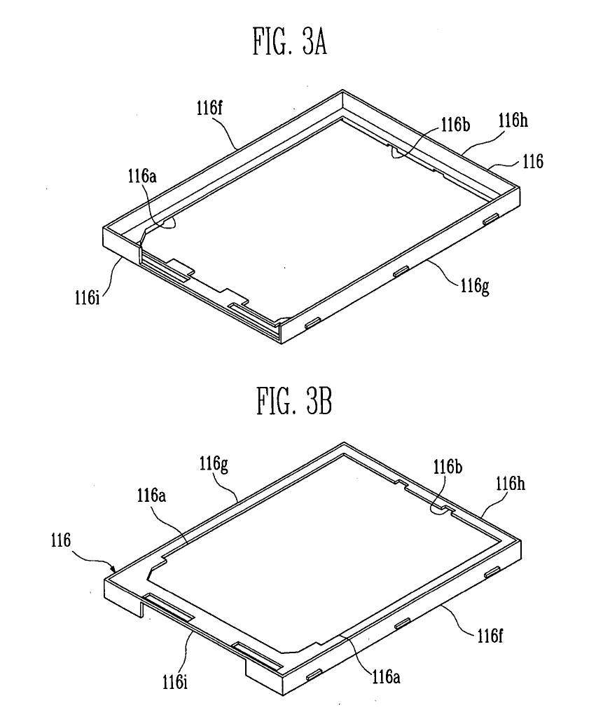

FIG. 1 illustrates an exploded, perspective view of a portable display device according to an embodiment of one or more aspects of the present invention. FIGS. 2A and 2B illustrate front and rear perspective views, respectively, of an exemplary light guiding member according to one or more aspects of the invention. FIGS. 3A and 3B illustrate front and rear perspective views, respectively, of an exemplary embodiment of a frame according to one or more aspects of the invention. In the following description, aspects of the present invention are illustrated in relation to a dual display device of a mobile telephone, as an exemplary electronic device that may employ aspects of the invention. Aspects of the invention are not, however, limited for use with such a dual display device for mobile telephones.

As illustrated in FIG. 1, a portable display device employing one or more aspects of the invention may include a LCD panel 104, a back light assembly 150, a bottom frame 122, first and second PCBs 124 and 126, and a light emitting display panel 130.

Although the LCD panel 104 and the light emitting display panel 130 are illustrated and described, various other types of display devices may be employed to display images on electronic devices employing one or more aspects of the invention. The LCD panel 104 may include a first substrate 104a, a second substrate 104b, and liquid crystal material (not illustrated) between the first substrate 104a and the second substrate 104b.

The second substrate 104b may include a plurality of transistors, e.g., TFTs. The transistors may be arranged in a matrix pattern. Source electrodes of the TFTs may be connected to data lines, and gate electrodes of the TFTs may be connected to scan lines. Drain electrodes of the TFTs may be connected to pixel electrodes made of conductive and transparent material, e.g., ITO. The TFTs may be turned on when scan signals are supplied to the scan lines, and data signals are supplied from the data lines to the pixel electrodes.

An integrated circuit 106, from which the data signals and the scan signals may be supplied, may be attached to one side of the second substrate 104b. A protective layer 108 may be formed around the integrated circuit 106.

The first substrate 104a may be arranged to face the second substrate 104b. Common electrodes made of ITO may be formed on the front surface of the first substrate 104a. A predetermined voltage may be applied to the common electrodes to form a predetermined electric field between the common electrodes and the pixel electrodes. The arrangement angle of the liquid crystal provided between the first substrate 104a and the second substrate 104b may be changed according to characteristics of the formed electric field. Light transmittance through the LCD panel 104 may change according to the arrangement angles of the liquid crystal material between the first substrate 104a and the second substrate 104b, to thereby display desired images on the LCD panel 104.

The back light assembly 150 may include a frame 116, light emitting diodes 112, a light emitting diode substrate 114, a light guiding member 118, a reflecting member 120, and optical sheets 110.

The light emitting diodes 112 may generate light of predetermined brightness in response to driving signals from a light source, e.g., the light emitting diode substrate 114.

The light guiding member 118, e.g., a light guiding plate, may supply the light supplied from the light emitting diodes 112 to the LCD panel 104. For example, the light guiding member 118 may supply the light supplied from the sides thereof to the LCD panel 104 positioned thereon.

The light guiding member 118 may be accommodated in and fastened to a lower part of the frame 116. In embodiments of the invention, the light guiding member 118 may include one or more first protrusions 118a and one or more second protrusions 118b, which may protrude from lower portions of the light guiding member 118. The first and second protrusions 118a, 118b may be received by corresponding portions of the frame 116. As illustrated in FIG. 1, the frame 116 may include one or more first receiving portions 116a and one or more second receiving portions 116b. The receiving portions 116a, 116b may be, e.g., a cavity, cut-out portion, or groove in a side of the frame 116. Although the following description and FIGS. 1-4B illustrate the frame 116 as including receiving portions, i.e., first and second receiving portions 116a and 116b, and the light guiding member 118 including first and second protrusions 118a and 118b, embodiments of the invention are not limited to such a structure. For example, the light guiding member 118 may include receiving portions and the frame 116 may include protrusions.

Exemplary embodiments of the protrusions 118a, 118b will be described in detail with reference to FIGS. 2A and 2B. FIG. 2A illustrates a front surface 118j of the light guiding member 118, and FIG. 2B illustrates a rear surface 118k of the light guiding member 118. In the exemplary embodiment illustrated in FIGS. 2A and 2B, the light guiding member 118 includes two first protrusions 118a and two second protrusions 118b. As illustrated in FIGS. 2A and 2B, the first protrusions 118a may extend along lower portions of the light guiding member 118 on, e.g., sides 118f, 118g of the light guiding member 118. The first protrusions 118a may extend along substantially an entire length of the sides of the respective sides 118f, 118g of the light guiding member. For example, the first protrusions 118a may extend along a portion of or entire side(s) 118f, 118g of the light guiding member 118, but not along side 118i at the end portion of the light guiding member 118 that corresponds to where the light emitting diode substrate 114 may be arranged.

As illustrated in FIGS. 2A and 2B, the second protrusions 118b may project from a side 118h of the light guiding member 118 that is opposite to the side 118i corresponding to where the light emitting diode substrate 114 may be arranged. A length of the second protrusion(s) 118b may be less than a length of the first protrusion(s) 118a. Although FIGS. 2A and 2B illustrate the first protrusions 118a are projecting from the opposing sides 118f, 118g and the second protrusions 118b are projecting from the side 118h, embodiments of the invention are not limited to such a structure.

Exemplary embodiments of the first and second protrusions 116a, 116b will be described in detail with reference to FIGS. 3A and 3B. FIG. 3A illustrates a front perspective view of the frame 116, and FIG. 3B illustrates a rear perspective view of the frame 116. In the exemplary embodiment illustrated in FIGS. 3A and 3B, the frame 116 may include two first receiving portions 116a and two second receiving portions 116b, respectively corresponding to the number of first protrusions 118a and second protrusions 118b of the light guiding member 118.

As illustrated in FIGS. 3A and 3B, the first receiving portions 116a may be formed on sides 116f, 116g of the frame 116, and the second receiving portions 116b may be formed on side 116h of the frame 116. The first receiving portions 116a may extend along lower portions of the frame on, e.g., sides 116f, 116g of the frame 116. The first receiving portions 116a may extend substantially an entire length of the sides of the respective sides 116f, 116g of the frame. For example, the first receiving portions 116a may extend along entire side(s) 116f, 116g of the frame 116, but for the side 116i at the end portion of the frame 116 that corresponds to the side of the display device where the light emitting diode substrate 114 may be arranged.

As illustrated in FIGS. 3A and 3B, the second receiving portions 116b may project from a side 116h of the frame 116 that is opposite to the side 116i corresponding to the side of the display device where the light emitting diode substrate 114 may be arranged. A length of the second receiving portion(s) 116b may be less than a length of the first receiving portion(s) 116a. Although FIGS. 2A and 2B illustrate the first receiving portions 116a are formed on the opposing sides 116f, 116g, and the second receiving portions 116b are formed on the side 116h, embodiments of the invention are not limited to such a structure.

In embodiments of the invention, a shape, size, placement and/or number of receiving portions, e.g., first and second receiving portions 116a, 116b, may correspond to a shape, size, placement and/or number of protrusions, e.g., first and second protrusions 118a, 118b.

In embodiments of the invention, side 116i of the frame 116 may not include a receiving portion, and side 118i of the light guiding member 118 may not include a protrusion for engaging with the frame 116. In embodiments of the invention, all the projections, e.g., first and second projections 118a, 118b, may project from a same portion, e.g., lower portion or upper portion, of the respective member/frame, e.g., light guiding member, and all the receiving portions, e.g., first and second receiving portions 116a, 116b, may be formed on a same portion, e.g., lower portion or upper portion, of the respective member/frame, e.g., frame 116.

By providing all the receiving portions, e.g., 116a, 116b, and all the protrusions, e.g., 118a, 118b, on respective same portions, e.g., lower or upper, of, e.g., the frame 116 and the light guiding member 118, attachment and/or engagement of the frame 116 with the light guiding member 118 may be simplified, and an assembly time associated with such a process may be reduced. In embodiments of the invention, a number of the first and/or second protrusions 118a and 118b formed on the sides of the light guiding member 118 and a number of the first and/or second receiving portions 116a and 116b formed on the internal sides of the frame 116 may be reduced. That is, in embodiments of the invention, arrangement of the first and/or second protrusions 118a and 118b and the first and/or second receiving portions 116a and 116b is simplified, such that manufacturing cost and manufacturing time of the light guiding member 118 and the frame 116 are reduced.

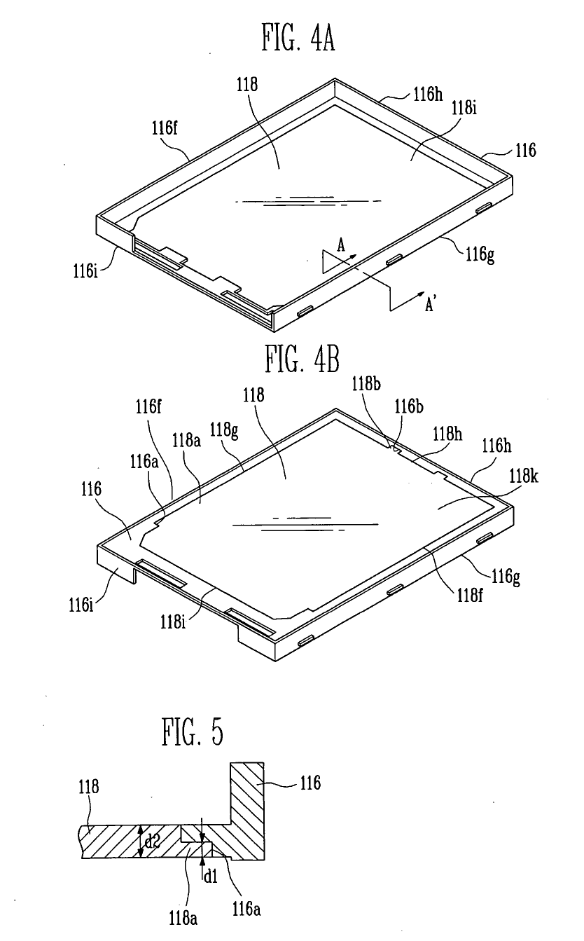

FIGS. 4A and 4B illustrate front and rear perspective views of exemplary embodiments of the frame 116 and the light guiding member illustrated in FIGS. 1 to 3B in an attached or assembled state. FIG. 4A illustrates the front perspective view of the frame 116 and the light guiding member 118 in the attached or assembled state, and FIG. 4B illustrates the rear perspective view of the frame 116 and the light guiding member 118 in the attached or assembled state. FIG. 5 is a sectional view of the exemplary light guiding member 118 and the exemplary frame 116, taken along line A-A′ of FIG. 4A.

Referring to FIGS. 4A, 4B and 5, the light guiding member 118 may be accommodated in, e.g., the lower parts of the internal sides of the frame 116. The first protrusions 118a, which may be formed, e.g., on the sides 118f, 118g of the light guiding member 118, may be settled in the first receiving portions 116a formed on the internal sides of the frame 116, and the second protrusions 118b, which may be formed, e.g., on the internal side 118h of the light guiding member 118, may be settled in the second receiving portions 116b.

The first protrusions 118aand the first receiving portions 116a may be formed in the lower portions of the two sides 118f, 118g of the light guiding member 118 and the frame 116, respectively, thereby enabling a simple assembly process, while providing a structure for stably supporting the back light assembly 150. In embodiments of the invention, the first protrusions 118a may be formed to extend in the longitudinal direction along respective sides 118f, 118g of the light guiding member to stably engage the frame 116 and the light guiding member 118 with each other such that the back light assembly 150 is stably supported, and an amount of displacement with respect to the bending of the back light assembly 150, which may be generated by external force, is reduced and/or prevented. That is, embodiments of the invention provide and enable a simple assembly process, while providing a structure for stably supporting the back light assembly 150. Embodiments of the invention enable a simple assembly process that does not require alignment and engagement of protrusions and receiving portions on both upper and portions of sides of a light guiding member and a frame of the display device.

In embodiments of the invention, the first protrusions 118a and the second protrusions 118b may protrude a same distance away from respective sides 118f, 118g and. 118h of the light guiding member 118. Referring to FIG. 5, in embodiments of the invention, a thickness d1 of the first protrusions 118a and the second protrusions 118b may range from about 0.4 to about 0.6 times a thickness d2 of the light guiding member 118. For example, when the thickness d2 of the light guiding member 118 is 0.65 mm, the thickness d1 of the protrusions 118a and 118b may be 0.3 mm.

In embodiments of the invention, the first and second protrusions 118a and 118b, and the first and second receiving portions 116a and 116b may be positioned in lower portions of the sides of the light guiding member 118 such that the first and second protrusions 118a and 118b may not be visible when viewing the frame 116 and the light guiding member 118 in an attached or assembled state, from a front side thereof. In such embodiments of the invention, the first and second protrusions 118aand 118b may be visible from when viewing the frame 116 and the light guiding member 118 in an attached state, from a rear side thereof.

The reflecting member 120 may be arranged on a side of the light guiding member 118 opposite to a side of the light guiding member 118 corresponding to where the light emitting diode substrate 114 may be arranged. In embodiments of the invention, the rear surface 118k of the light guiding member 118 may face and/or contact the reflecting member 120. The reflecting member 120 may re-supply the light incident from the light guiding member 118 to the light guiding member 118. That is, the reflecting member 120 re-supplies or re-directs the light incident thereon to the light guiding member 118 to improve optical efficiency. The optical sheets 110 may increase the brightness of the light being supplied from the light guiding member 118 to the LCD panel 104.

The light emitting diode substrate 114, with the light emitting diodes 112 arranged therein, the LCD panel 104, and the back light assembly 150 may be accommodated in and fixed to the frame 116. Receiving portions, e.g., grooves, for stably receiving the back light assembly 150 may be formed on the sides, e.g., 116f, 116g, of the frame 116. For example, as discussed above, the first and second receiving portions 116a and 116b for settling and receiving the light guiding member 118 may be formed on the internal sides 116f, 116g, 116h of the frame 116. Embodiments of the invention may enable a smaller number of protrusions, e.g., first and second protrusions 118a and 118b, positioned on the sides, e.g., sides 118f, 118g, 118h, of the light guiding member 118 to be employed while providing a stable structure that is simple to assemble. Embodiments of the invention may separately provide a simplified arrangement and assembly structure for the protrusions, e.g., first and second protrusions 118a and 118b, by forming the first and second protrusions 118a, 118b and the receiving portions, e.g., first and second receiving portions 116a, 116b, respectively, on same portions, e.g., lower portions or upper portions, of the light guiding member 118 and frame 116. In embodiments of the invention, all of the receiving portions 116a, 116b may be formed on internal sides of the frame 116.

Referring to FIG. 1, the bottom frame 122 may be fixed to the frame 116. For example, bottom side portions of the bottom frame 122 may engage with the bottom side portions of the frame 116. An aperture may be formed in a part of the bottom frame 122 so that the light emitting display panel 130, which is a second display panel, can be inserted into the bottom frame 122.

Referring to FIG. 1, the second printed circuit board 126 may receive driving signals from a driving circuit of an electronic device (not illustrated), e.g., a mobile telephone. The second printed circuit board 126 may include, e.g., a mobile telephone connector 128. The mobile telephone connector 128 may be fixed to another connector attached to the driving circuit of the mobile telephone to receive the driving signals from the driving circuit of the mobile telephone. The second printed circuit board 126 may generate various control signals in response to the received driving signals, e.g., driving signals received from the driving circuit of the mobile telephone or other electronic device.

The first printed circuit board 124 may be connected to the second printed circuit board 126 via a first pad unit 138 formed in the second printed circuit board 126. The first printed circuit board 124 may be connected to the integrated circuit 106 of the LCD panel 104 and the light emitting diode substrate 114 by a flexible printed circuit board (not illustrated).

The light emitting diode substrate 114 may be connected to the first printed circuit board 124. The first printed circuit board 124 may supply driving signals for driving the integrated circuit 106 and the light emitting diode substrate 114 based on the control signals received from the second printed circuit board 126.

The light emitting display panel 130 may include a first substrate 130a and a second substrate 130b. Organic light emitting diodes (OLEDs) (not illustrated) may be arranged on the first substrate 130a in, e.g., a matrix pattern. The OLEDs may generate light of predetermined brightness in response to the amount of current supplied thereto. The light emitting display panel 130 may be connected to the second printed circuit board 126 by the second pad unit 136 of a flexible printed circuit board 132. An integrated circuit 134 may be mounted on the flexible printed circuit board 132. The integrated circuit 134 may drive the light emitting display panel 130 to display predetermined images based on control signals supplied from, e.g., the second printed circuit board 126, to the integrated circuit 134.

As described above, embodiments of a portable display device employing one or more aspects of the invention may employ a fewer number of protrusions on the sides of the light guiding member and a fewer number of receiving portions formed on the internal sides of the frame, and an arrangement of the protrusions and the receiving portions is simplified so that it is possible to reduce the manufacturing time and cost of the light guiding member and the frame. Also, processes of settling the protrusions in the receiving portions are simplified so that it is possible to reduce the time and cost required for combining the light guiding member and the frame with each other. By providing a structure in which the first protrusions may be formed in the lower parts of, e.g., opposing sides of the light guiding member in a longitudinal direction, the protrusions may stably fasten the frame and the light guiding member to each other while providing a structure that stably supports the back light assembly and reduces and/or prevents an amount of displacement with respect to the bending of the back light assembly, which may result from external force applied thereto.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A display device, comprising:
a liquid crystal display panel;
a back light assembly including a light source for supplying light to the liquid crystal display panel;
a light guiding member included in the back light assembly to supply light from the light source to the liquid crystal display panel;
a frame for accommodating the liquid crystal panel, the light source, and the light guiding member;
a first protrusion formed on each of a first side and a second side of the light guiding member, the first protrusions extending from a lower portion or upper portion of the first and second sides; and
at least one second protrusion formed at least on a third side of the light guiding member, the second protrusion extending from a lower portion or upper portion of the third side,
wherein the at least one second protrusion is shorter than at least one of the first protrusions.

2. The display device as claimed in claim 1, wherein the first side and the second side of the light guiding member are opposed to each other.

3. The display device as claimed in claim 1, wherein the light guiding member includes a fourth side where the light source is arranged, and the third side of the light guiding member opposes the fourth side of the light guiding member.

4. The display device as claimed in claim 1, wherein a thickness of the first protrusions ranges from about 0.4 times to about 0.6 times a thickness of the light guiding member.

5. The display device as claimed in claim 1, wherein a thickness of the second protrusions ranges from about 0.4 times to about 0.6 times a thickness of the light guiding member.

6. The display device as claimed in claim 5, wherein a thickness of the first protrusions ranges from about 0.4 times to about 0.6 times the thickness of the light guiding member.

7. The display device as claimed in claim 1, wherein:
the frame includes first receiving portions for receiving the first protrusions and at least one second receiving portion for receiving the at least one second protrusion, the first and second receiving portions being formed in lower portions or upper portions of internal sides of the frame,
when the first protrusions and the at least one second protrusion are formed on the lower portions of the first, second and third sides of the light guiding member, respectively, the first and second receiving portions are formed on the lower portions of the internal sides of the frame, and
when the first protrusions and the at least one second protrusion are formed on the upper portions of the first, second and third sides of the light guiding member, respectively, the first and second receiving portions are formed on the upper portions of the internal sides of the frame.

8. The display device as claimed in claim 7, wherein at least orie of the first receiving portions is formed on each of first and second sides of the frame, the first and second sides of the frame opposing each other and corresponding to the first and second sides of the light guiding member when the light guiding member and the frame are in an assembled state.

9. The display device as claimed in claim 7, wherein the at least one second receiving portion is formed on the third side of the frame that opposes a fourth side of the frame where the light source is arranged.

10. The display device as claimed in claim 7, wherein the first receiving portions extend further than the at least one second receiving portion extends.

11. The display device as claimed in claim 1, wherein the first protrusions extend substantially along an entire distance of the respective one of the first and second sides of the light guiding member.

12. The display device as claimed in claim 1, further comprising a reflecting member arranged below the light guiding member.

13. A light guiding member employable in a display device, the light guiding member comprising:
an upper surface and a lower surface that overlaps with the upper surface;
first, second and third side surfaces;
a first protrusion extending from a lower or upper portion of each of the first side surface and the second side surface of the light guiding member;
at least one second protrusion extending from a lower or upper portion of the third side surface of the light guiding member, wherein the at least one second protrusion extends along the third side surface a shorter distance than at least one of the first protrusions extends along the respective one of the first and second side surfaces.

14. The light guiding member as claimed in claim 13, wherein a thickness of the first protrusions ranges from about 0.4 times to about 0.6 times a thickness of the light guiding member.

15. The light guiding member as claimed in claim 13, wherein a thickness of the second protrusions ranges from about 0.4 times to about 0.6 times a thickness of the light guiding member.

16. The light guiding member as claimed in claim 13, wherein the first protrusions extend along substantially an entire length of the respective first and second side surfaces.

17. The light guiding member as claimed in claim 13, wherein an upper portion of each of the first, second and third side surfaces is free of protrusions.

18. The light guiding member as claimed in claim 13, wherein a fourth side surface of the light guiding member that opposes the third side surface of the light guiding member is free of protrusions.

19. A frame structure connectable to a light guiding member of a display device, the frame structure comprising:
first, second and third inner side surfaces;
a first receiving portion on a lower or upper portion of each of the first and second inner side surfaces of the frame;
at least one second receiving portion on a lower or upper portion of the third inner side surface of the frame;
wherein the first receiving portions have a length along the respective first and second side surfaces of the frame that is longer than a length of the at least one second receiving portion that extends along the third side surface of the frame.

20. The frame structure as claimed in claim 19, wherein the first inner side surface and the second inner side surface are opposed to each other.
